(19) United States
(12) Patent Application Publication
(10) Pub. No.: US 2003/0105878 A1
(43) Pub. Date: Jun. 5, 2003

(54) Method for transmitting data packets containing private internet addresses

(76) Inventors: Joerg Ottensmeyer, Hoehenkirchen (DE); Bernhard Petri, Munich (DE)

Correspondence Address: MORRISON & FOERSTER LLP, 1650 TYSONS BOULEVARD, SUITE 300, MCLEAN, VA, 22102, US

(21) Appl. No.: 10/168,400

(22) PCT Filed: Dec. 19, 2000
(86) PCT No.: PCT/DE00/04530

(30) Foreign Application Priority Data
Dec. 22, 1999 (DE) 199 62 238.8

(51) Int. Cl. G06F 15/16

(52) U.S. Cl. 709/245

(57) ABSTRACT

The invention relates to a method for transmitting data packets containing private Internet addresses. In prior art, the transmission of data packets containing private IP addresses is problematic, as said addresses are not unequivocal on a world-wide basis. According to the invention, at least one field is provided in the information block of an IP packet which can accommodate an identification that indicates a private network which is unique world-wide. This identification determines the interpretation of the subsequent (private) IP addresses.

### CLAIM FOR PRIORITY

This application claims priority to International Application No. PCT/DE00/04530 which was published in the German language on Jun. 28, 2001.

### TECHNICAL FIELD OF THE INVENTION

The invention relates to a method for transmitting data packets with addresses in multiple networks.

### BACKGROUND OF THE INVENTION

In the prior art, there is the problem of how to ensure that Internet subscribers can be accessed in private networks at all times. It is problematic that the official IP addresses used are limited in number. As subscribers can be assigned to private networks, they also receive private IP addresses with corresponding frequency. In this context, a private IP address is understood to be an address which is applied in a specific address space. Within this address space, these addresses can be evaluated by any device. However, in foreign private networks there is a problem since this network uses other private IP addresses and it is not possible to evaluate foreign private IP addresses.

In order to solve this problem, concepts are currently being developed which permit either all the private IP addresses used in the network to be transmitted and evaluated or enable the use of private IP addresses to be avoided, for example “NAT”(Network Address Translation), “RSIP” (Realm-Specific IP), “IPv6” (next generation Internet Protocol). However, in this context there is the problem that it is necessary to intervene more deeply in the Internet protocol or in applications, or even to develop a completely new Internet protocol. However, in practice this involves enormous expenditure.

### SUMMARY OF THE INVENTION

The invention discloses transmitting private IP addresses efficiently and without modifications of the transmission protocol.

In one embodiment of the invention, at least one field in which an identification which characterizes a private network and is unique worldwide is entered is provided in the information part of an IP packet. This identification can then be followed by a private IP address. In this way, it is possible to identify a private IP address in any private network throughout the world to determine in which address space it is valid.

The invention can be used in a large number of situations. The advantages become particularly clear in the field of mobile subscribers where this solution can be used to ensure that mobile Internet subscribers in the network can be accessed. Moreover, the invention can also generally be used as a solution for exchanging information in the Internet. The invention thus fulfills in particular three requirements:

no change to the APIs used for Internet access, i.e. existing applications can continue to be used without modification,

no new supplementary protocol with independent information flows,

end-to-end transparency for applications.

### BRIEF DESCRIPTION OF THE DRAWINGS

The invention is explained in more detail below by the exemplary embodiments, in which:

FIG. 1 shows an international communications network which is formed from a multiplicity of private networks and has mobile IP-specific functional elements.

FIG. 2 shows the conditions in an IP packet.

### DETAILED DESCRIPTION OF THE PREFERRED EMBODIMENTS

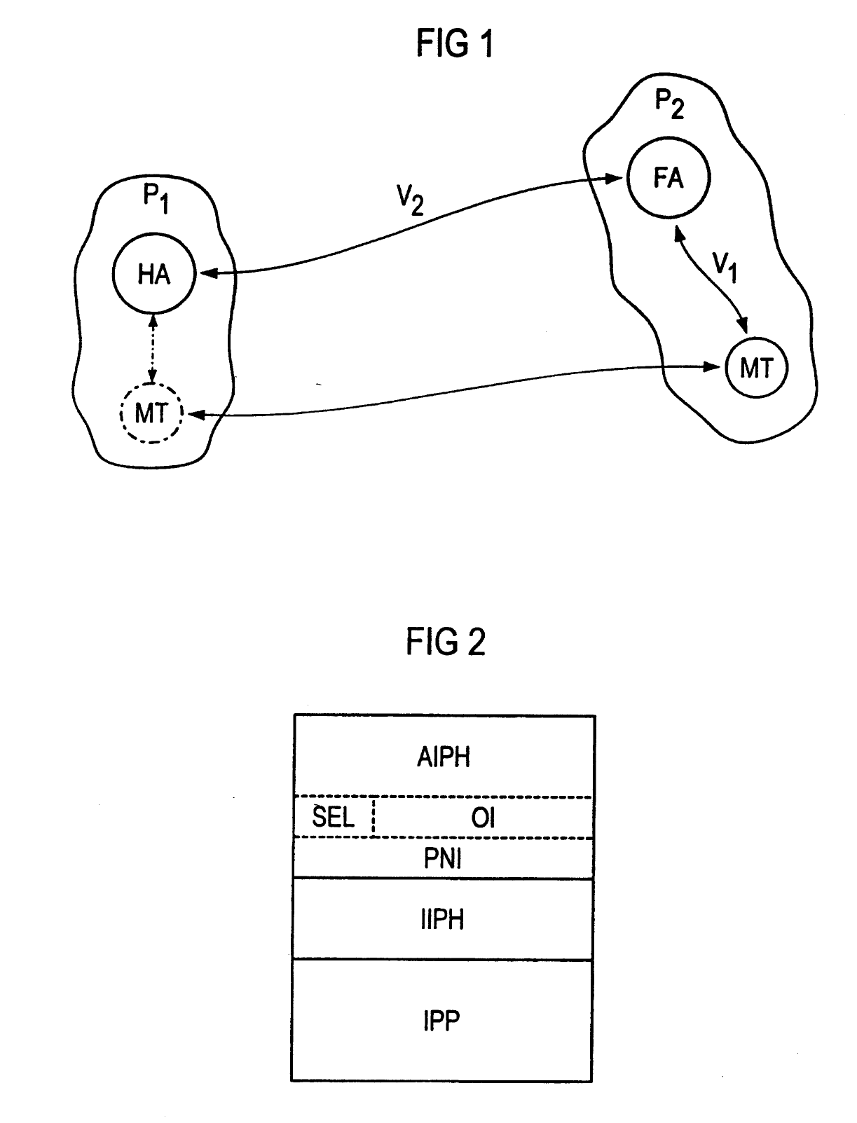

FIG. 1 shows a network in which information is to be transmitted in accordance with an Internet protocol. The network is to be formed from a multiplicity of private and public networks, two private networks P₁, P₂ being shown in FIG. 1. For the use of mobile IPs, a home agent HA is required which is arranged in the private network P₁ and which includes data which is referred to subscriber in table form and addresses of mobile subscriber included in the data. A foreign agent FA (foreign to the subscriber of the network P₁) is arranged in the private network P₂. It is then assumed that one of the mobile subscribers of the network P₁, for example the subscriber MT, changes his location. The network which is assigned to the new location will be the private network P₂ with the foreign agent FA.

First, the subscriber MT makes contact with the foreign agent FA (V₁) and receives a “care-of-address”. He then signals the IP address to the home agents HA of the subscriber MT with (V₂) via the foreign agent (FA). If the home agent HA then receives a data packet for the subscriber MT, he is thus able to route it to the foreign agent FA, and thus to the mobile subscriber MT.

With respect to the invention, particularly the cases in which the home agent is part of a private network and/or the foreign agent is also part of a private network which is foreign from the point of view of the subscriber who is changing over are of interest. As the IP-IP tunneling which is used in mobile IPs, as described in RFC 2003, is based on public addresses, the respective agents cannot communicate with one another. However, the invention can be used by subscribers to communicate with one another irrespective of the location so that the mobile IP method can also be used in the configurations described.

In order to implement these processes, the transmission format is to be modified in a way which is transparent to transit network components. The respective conditions are given in FIG. 2.

Here, the technology of “IP-IP tunnels”, such as are also used by mobile Internet subscribers, is further developed. In the case of IP-IP tunnels, IP packets are integrated (encapsulated) into other IP packets. If in this case a private IP address (that is to say one which is not uniform worldwide) were used in the internal IP packet, the receiver (for example the foreign agent) would not be able to assign it when unpacking the IP packet without modification. In the case of a mobile IP, a mobile subscriber who has received a private IP address at a remote location would therefore not be able to signal it to his home agent appropriately.

FIG. 2 shows an external IP header AIPH, an internal IP header IIPH and the IP payload IPP. Here, the addresses which are valid in the respective network are given in the external IP header AIPH. The encapsulated IP addresses (for example of the mobile subscriber MT) are included in the internal IP header IIPH.

The invention solves the problem of using private IP addresses in IP-IP tunnels by using a classification system for private IP addresses. Such a system is already being used, for example, at another location in the IETF for providing VPNs (Virtual Private Networks) (VPN-IDs, RFC 2685). This makes it possible to identify and transfer the address space associated with a private address, and thus indicate it to the receiver. The interpretation of the encapsulated IP addresses results from the integrated address space identifier and the private IP address. The address space identifier includes an identifier OI, which is representative of a specific organizational unit which, for example, operates the respective private network. This identifier can be assigned by a superordinate (for example recognized worldwide) organization (for example the IEEE). This organizational unit can be uniquely identified worldwide by means of the identifier OI. As each organizational unit can possibly have several networks and thus address spaces, this identifier OI is supplemented with a further identifier PNI for identifying the address space. The address space identifier determines the association of the IP addresses used in the internal header IIPH with an address space.

In FIG. 2, the field OI is to be considered the identifier which designates the respective organizational unit. This identifier is valid and unique worldwide. Furthermore, in FIG. 2 there is a field PNI in which the address space identifier of this organizational unit is stored. A further field SEL is used as an identification of whether and how the IP address space designated in this way relates to the transmitter's address or destination address, or to both. This selector is also used to indicate the case in which the internal transmitter's IP address and destination IP address are associated with different foreign IP address spaces. In this case, two different address space identifiers must then be used, one for the transmitter's address and one for the destination address.

However, the invention is not restricted to this application (MobileIP). Instead, the solution which is described in this way can also be generally taken as a basis for the further development of the Internet.

In addition to the two-stage classification system (OI/PNI) proposed above for private IP addresses, any other classification system which is unique worldwide can also be used. Further possible examples of this are, for example, systems on the basis of the SMI Private Vendor Extension (as, for example, used in section 5.26 of IETF RFC 2138/RADIUS) or the ASN.1 Object Identification System (ITU-T Rec. X.208).

1. A method for transmitting data packets with private Internet addresses, with a multiplicity of private networks (P₁ . . . Pₙ) which are networked to one another via public networks or other private networks, private and public networks each comprising a further multiplicity of subscribers which can be addressed via public or private IP addresses and which exchange information with one another in the form of IP packets, a destination address (AIPH) being entered into the packet header of an IP packet, and the information which is to be exchanged being entered into the information part of an IP packet,
characterized
in that at least one field (OI, PNI) in which an identification which characterizes a private network (P₁ . . . Pₙ) and is unique worldwide is entered is provided in the information part of an IP packet.

2. The method as claimed in claim 1,
characterized
in that the identification which characterizes the private network (P₁ . . . Pₙ) and is unique worldwide is composed of an identification number for an organization (OI), and of an address space identifier (PNI) which is to be administered by this organization.

3. The method as claimed in claim 1, 2,
characterized
in that the identification which characterizes the private network (P₁ . . . Pₙ) and is unique worldwide is followed by at least one private IP address.

4. The method as claimed in one of the preceding claims,
characterized
in that some of the subscribers are embodied as mobile Internet subscribers.

5. The method as claimed in one of the preceding claims,
characterized
in that the at least one field contains information (SEL) about whether and how the included identification which characterizes the private network (P₁ . . . Pₙ) and is unique worldwide relates to the transmitter's address or destination address or both.
